(19) United States
(12) Patent Application Publication
(10) Pub. No.: US 2005/0232177 A1
(43) Pub. Date: Oct. 20, 2005

(54) Method for transmission power control of a multicast signal

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/525,481

(22) PCT Filed: Aug. 18, 2003
(86) PCT No.: PCT/IB03/03750

§ 371 Date: Feb. 23, 2005

(30) Foreign Application Priority Data
Aug. 30, 2002 (EP) 021022512

(51) Int. Cl. H04J 3/08; H04B 7/14

(52) U.S. Cl. 370/315; 455/1

(57) ABSTRACT

The invention relates to a method for controlling the transmission power employed by a transmitting unit for transmitting multicast signals via a radio interface to communication devices of a multicast group using a single physical channel. In order to enable an efficient power control, it is proposed that at least the communication device receiving the weakest multicast signals transmits power control commands to the transmitting unit. Further, it is proposed that the transmitting unit adjusts the transmission power based on power control commands received from at least one of the communication devices in a way that the power control commands of the communication device receiving the multicast signals with the lowest quality have the most significant influence on the adjustment. The invention relates equally to a corresponding transmitting unit, to a corresponding communication device and to a corresponding communication system.

The invention relates to a method for controlling the transmission power which is employed by a transmitting unit for transmitting multicast signals via a radio interface to at least two communication devices of a multicast group using a single physical channel. The invention relates equally to such a transmitting unit, to such a communication device and to a communication system.

It is known from the state of the art to control the transmission power of downlink signals which are transmitted by a network unit of a communication network via a radio interface to a receiving communication device. Such a power control allows in particular to compensate for varying channel conditions between the network unit and the receiving communication device. In general, it is an aim to employ a transmission power which it is sufficiently high for a reliable reception of transmitted signals at the communication device, but which is at the same time not higher than necessary. In a closed loop power control, the network unit transmits signals to the communication device, and the communication device provides a feedback to the network unit. The network unit is then able to adjust the transmission power based on this feedback.

Especially for CDMA (Code Division Multiple Access) radio systems, a fast closed loop power control is essential to cope with fading channels. In the downlink, such a fast closed loop power control can be achieved by ensuring that a communication device which receives signals on a downlink channel sends power control commands every time slot to the transmitting network unit. In UMTS (Universal Mobile Telecommunication Services) systems, for example, this corresponds to a transmission of a power control command every ⅔ ms.

A closed loop power control for downlink transmissions is described in the technical specification 3GPP TS 25.214 V5.1.0 (2002-06): “3rd Generation Partnership Project;
Technical Specification Group Radio Access Network; Physical layer procedures (FDD) (Release 5)”.

According to this specification, the transmission power of the downlink channels is determined by the network. The downlink transmission power control procedure controls simultaneously the power of a DPCCH (Dedicated Physical Control Channel) and its corresponding DPDCH (Dedicated Physical Data Channels). Each communication device generates TPC (transmit power control) commands to control the network transmit power and sends them in a dedicated TPC field of an uplink DPCCH to the network. Upon receiving the TPC commands, the UTRAN (UMTS Terrestrial Radio Access Network) adjusts its downlink DPCCH/DPDCH power for the respective connection accordingly.

The TPC commands can be determined by a communication device for instance such that the received downlink SIR (Signal-to-Interference Ratio) is kept at a given SIR target. To this end, the communication device may estimate the received downlink DPCCH/DPDCH power of the connection which is to be power controlled, estimate the received interference and calculate from these estimates an SIR. The obtained SIR estimate can then be used by the communication device to generate TPC commands. If the SIR estimate is larger than a predetermined SIR value, a TPC command ‘0’ may be transmitted for requesting a reduction of the transmission power. If the SIR estimate is smaller than the predetermined SIR value, a TPC command “1” may be transmitted for requesting a transmit power increase.

Equally known from the state of the art are multicast transmissions. A multicast transmission is a transmission of identical information from a transmitting unit to a group of selected receiving units belonging to a multicast group. In a communication system which is based on transmissions via a radio interface, such a multicast transmission can be realized between a base station forming a network unit of a communication network and a plurality of communication devices accessing the communication network via this base station.

In a radio environment, multicast transmissions are most efficient if the information is transmitted simultaneously to the communication devices of a multicast group using the same physical channel for all communication devices. In the case of CDMA, using a single downlink physical channel for all communication devices of a multicast group requires in terms of spreading codes the absolute minimum of resources for conveying the data to all communication devices.

Usually, the communication devices of a multicast group will not see the same channel conditions during a multicast transmission. In case of a closed loop power control, the communication devices will therefore generate and transmit different power control commands. More specifically, a communication device with good channel conditions will not request a change of the transmission power, it might even indicate that the power could be reduced. At the same time, another communication device of the same multicast group might-request an increase of the transmission power due to bad channel conditions. In case a single physical channel is employed for multicast transmissions, however, the transmission power on this channel can obviously only be adjusted in common for all communication devices. Thus, the power control known for dedicated downlink transmissions may result in conflicts between the power control commands by different communication devices of a multicast group when applied to multicast transmissions.

It is an object of the invention to enable an efficient power control for multicast transmissions via a radio interface on a single physical channel to at least two communication devices of a multicast group.

On the one hand, a method is proposed for controlling the transmission power employed by a transmitting unit for transmitting such multicast signals. The transmitting unit can be in particular a network unit of a communication network, but equally any other unit suited for transmitting multicast signals. The method comprises that at least the communication device of the at least two communication devices receiving the multicast signals with the lowest quality transmits power control commands to the transmitting unit. These power control commands indicate whether the transmission power employed by the transmitting unit for transmitting the multicast signals should be increased or reduced.

In order to generate a power control command, the communication device advantageously first determines whether the quality of the received multicast signals is sufficiently high. If it is higher than required, a power control command is generated which indicates that the transmission power can be reduced. If it is lower than required, a power control command is generated which indicates that the transmission power should be increased.

In the proposed method, the transmitting unit further adjusts the transmission power based on power control commands received from at least one of the at least two communication devices in a way that the power control commands of the communication device receiving the multicast signals with the lowest quality has at least the most significant influence on the adjustment.

On the other hand, a transmitting unit and a communication device are proposed which comprises means for realizing the steps of the proposed method associated to a transmitting unit and to a communication device, respectively.

Further, a communication system is proposed which comprises such a transmitting unit and at least two such communication devices.

The invention proceeds from the consideration that the known power control mechanisms cannot be applied directly to multicast transmissions. It further proceeds from the consideration that the transmission power employed for multicast signals can only be sufficient in the case the communication device receiving the weakest multicast signals receives signals of a satisfying quality. According to the invention, a feedback by this communication device has therefore at least the largest, if not the only, influence on any adjustment of the transmission power.

It is an advantage of the invention that the transmission power for multicast signals for a specific multicast group can always be set to a level which allows the respective communication device of this multicast group seeing the worst channel conditions to receive the multicast signals with a sufficient power even while moving.

Preferred embodiments of the invention become apparent from the dependent claims.

In a first preferred embodiment of the invention, all communication devices of a multicast group run a power control loop and transmit power control commands to the transmitting unit. The transmitting unit increases the transmission power whenever it receives at least one power control command indicating that the transmission power should be increased. Moreover, the transmitting unit reduces the transmission power whenever it receives from all communication devices of the multicast group a power control command indicating that the transmission power may be reduced.

In this approach, the communication device receiving the multicast signals with the lowest quality will obviously request longer than any other communication device an increase of the transmission power. Since the power will be increased already in case only a single communication device requests an increase, the communication device receiving the multicast signals with the lowest quality has the largest influence on the increase of the transmission power. Further, this communication device will obviously be the last to propose a reduction of the transmission power. Since the power will only be reduced when all of the communication devices request a reduction, the communication device receiving the multicast signals with the lowest quality has also the largest influence on the reduction of the transmission power.

In a second preferred embodiment of the invention, the transmitting unit requests a selected one of the communication devices of the multicast group to provide power control commands. All other communication devices do not send any power control commands concerning the multicast channel. Thus, one of the communication devices of the multicast group is selected to be the multicast-power-control-master. In order to enable the transmitting unit to select one of the communication devices as master device, each of the communication devices provides some kind of quality indication to the transmitting unit, which quality indication reflects the quality of the multicast signals received by the respective communication device. The transmitting unit then selects the communication device of which the provided quality indication currently reflects the lowest quality of the multicast signals. The selection is preferably signaled in a dedicated message to the respective communication device. It is to be noted that the quality indications might also be given by power control commands transmitted at first by all communication devices. Only after a respective selection a single communication device will then transmit power control commands.

It is an advantage of this second approach that only the communication device seeing the worst channel conditions sends power control commands to the transmitting unit, while the other communication devices just receive the multicast data, since their channel conditions are better than those of the communication device sending power control commands. Possible ambiguities resulting from different commands by different communication devices are thereby avoided.

Since a single communication device takes over the role of a multicast-power-control-master, a hand-over of this function should by enabled. Thereby, it can be ensured that also with changing channel conditions, it is always the communication device currently receiving the multicast signals of the lowest quality which controls the downlink transmission power.

In a third preferred embodiment of the invention, each of the communication devices transmits a power control command to the transmitting unit, as in the first approach. In addition, each of the communication devices transmits as well a quality indication to the transmitting unit, as in the second approach. The quality indications reflects the quality of the multicast signals received by the respective communication device. The power control command of all communication devices are then weighted with factors which are based on these quality indications. The weighted power control commands are summed and compared with a predetermined value. The transmission power is increased or reduced based on this comparison. Again, the quality indications might be given by power control commands themselves. In this case, the communication devices transmit only power control commands, and the transmitting unit considers these power control commands in addition as quality indications.

According to the invention, the communication device which sees the worst channel conditions has to have at least the most significant influence on the power adjustment. This implies that in the third approach, the largest weight has to be assigned to the power control commands of the communication device which receives multicast signals with the lowest quality. This communication device, which constitutes again the multicast-power-control-master, can be determined based on the provided quality indications. The weighting of the power control commands can be such that exclusively the power control command of the multicast-power-control-master is considered, i.e. the weighting factor for the corresponding power control command is set for example to ‘1’, while the weighting factors for the power control commands of the other communication devices is set to ‘0’. Alternatively, the power control commands of the other communication devices are not neglected completely, i.e. the weighting factor for the power control command of the multicast-power-control-master is set to the largest value, but at least one of the other weighting factors is equally set to a value larger than zero.

For the proposed third approach, the transmitting unit does not have to indicate to a communication device that it is the multicast-power-control-master. It only needs the quality indication provided by each of the communication devices and decides without signaling which power control command should contribute how much to the power control of the multicast channel. Since the role of the multicast-power-control-master can be dynamically transferred between the communication devices, even though the communication devices are not aware of this, some kind of an implicit hand-over of the function of the multicast-power-control-master is performed.

Compared to the second approach, no additional signaling to a respective multicast-power-control-master is needed in the third approach. Since an extra signaling requires some additional time in the power adjustment, it is thus an advantage of this third approach that it enables a particularly fast power adjustment.

The quality indication in the second and the third preferred embodiment can be a single value which is based on a single quality parameter, a single value which is based on a combination of different quality parameters or comprise a plurality of values based on a plurality of quality parameters. In case each of the quality indications comprises different values, the transmitting unit may determine in the third preferred embodiment the weighting factors of the power control commands based on weighted different quality values.

It is to be noted that as long as the communication devices transmit uplink data anyhow in any of the presented embodiments, it is not necessary to run an additional DCH (dedicated channel) specifically for transmitting the power control commands and/or the quality indications to the transmitting unit. The required feedback information may then simply be transmitted on the established uplink channel. Such established uplink channels are present in many situations, e.g. in a telephone conferencing call with more than two communication devices served by the same cell.

The conventional commands for a power control are restricted to a first command requesting an increase of the transmission power and a second command requesting a reduction of the transmission power. In case the power is preferably kept as it is, the communication devices may then transmit the first and the second command alternatingly. For some systems, it might be useful to introduce in addition a new command which requires the power explicitly to be kept as it is.

The employed power control commands can be similar or identical to the known TPC commands specified in the above mentioned specification 3GPP TS 25.214. As in the specification, a dedicated field can be provided in uplink channels for the power control commands and/or for the quality indications.

The invention can be employed in particular, though not exclusively, for CDMA system. The invention can further be employed in particular, though not exclusively, for UMTS. In the case of UMTS, the functions of the proposed transmitting unit can be realized completely in a node B of an UTRAN, since the node B is in charge of power control command interpretations.

The transmitting unit according to the invention can be for example a base station, like a node B of an UTRAN, a part of a base station, or an entire radio access network, like an UTRAN. The communication device can be for example a mobile phone, but equally any other device which is able to communicate with a communication network via a radio interface. In the case of UMTS, the communication devices are referred to as user equipment.

It is understood that the presented embodiments of the invention can be varied and supplemented in many ways.

The invention will now be described in more detail by way of example and with reference to the attached drawing. The only figure is a flow chart which partially illustrates a preferred embodiment of the method of the invention.

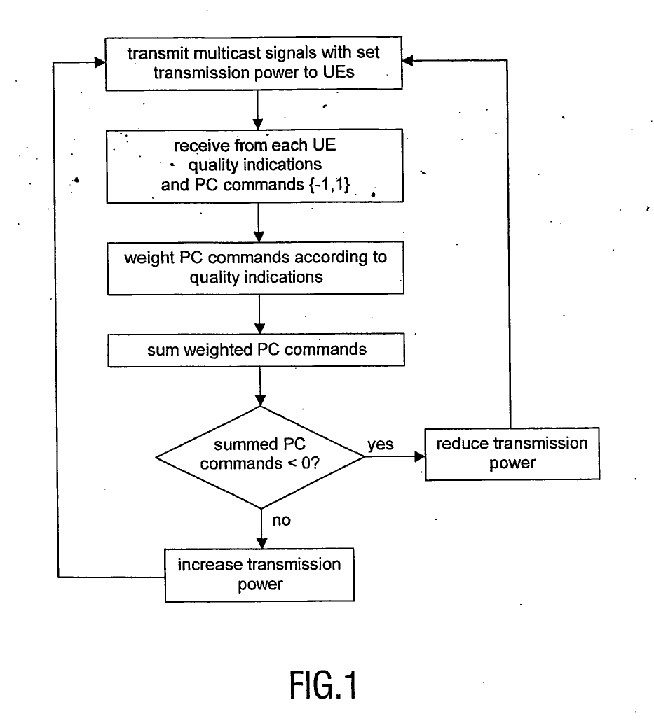

The method illustrated in FIG. 1 is implemented in a node B of an UTRAN of a mobile communication network. User equipment UE which is capable of UMTS is able to access the mobile communication network via this node B. Each UE which is registered to a multicast group is thereby able to receive multicast signals transmitted by the node B for the respective multicast group. The method illustrated in FIG. 1 is part of a power control loop which ensures that each UE of a multicast group is able to receive multicast signals transmitted by the node B for this multicast group during the entire time of transmission, while the transmission power is at the same time as low as possible in order to reduce interferences.

The node B transmits multicast signals for a specific multicast group via the air interface on a single physical channel to several UEs belonging to this multicast group. At first, the transmission power is set to a high value in the node B, in order to ensure that also those UEs having currently a weak reception on the employed multicast channel are able to receive the multicast signals. A weak reception may be due to a relatively great distance of the respective UE to the node B.

Each of the UEs receives the transmitted multicast signals, estimates the power of the downlink multicast connection and the received interference and calculates the SIR based on the estimates. The calculated SIR is then compared with a predetermined SIR value. In case the calculated SIR value lies above the predetermined SIR value, the power employed for the transmission of the multicast signals is assumed to be sufficiently high. In case the estimated SIR value lies below the predetermined SIR value, the power employed for the transmission of the multicast signals is assumed not to be high enough. The determination of the SIR and the subsequent comparison may thus correspond to the proposals in the above cited specification TS 25.214. Based on the comparison, each of the UEs then determines a power control command. A power control command of ‘1’ is selected for indicating that an increase of the transmission power is required, and a power control command of ‘−1’ is selected for indicating that a reduction of the transmission power is possible.

Further, each of the UEs determines a quality indication which is indicative of the current radio conditions on the multicast channel seen at the respective UE. The quality indication consists in the present example simply of the calculated SIR Alternatively or additionally, the quality indication could be based on any other value characterizing the current reception quality on the multicast channel, for example the current block error probability determined at the respective UE for the multicast channel.

The UE inserts the determined power control command into a dedicated power control command field and the determined quality indication into a dedicated quality indication field of an established dedicated uplink connection to the node B. In case for one or more of the UEs currently no uplink connection is established, a respective DCH is created specifically for transmitting the respective power control command and the respective quality indication to the node B.

As indicated in FIG. 1, the node B receives in a second step the provided power control (PC) commands and quality indications from all UEs of the multicast group.

By evaluating the quality indications, the node B determines the UE or UEs reporting the lowest SIR. To the power control commands of this UE or UEs, a weighting factor of ‘1’ is assigned. To the power control commands of all other UEs, a weighting factor of ‘0’ is assigned.

The node B then weights the received power control commands with the assigned weighting factors and sums the weighted power control commands, which steps are equally indicated in FIG. 1. Usually, only a single UE will report the lowest SIR, and thus the resulting sum will usually correspond to the power control command of ‘1’ or ‘−1’ provided by this UE.

In an alternative approach, weighting factors larger than zero could be assigned to all or several of the UEs, in particular in case different values are included in the quality indications. Also in this case, however, the power control command of the UE reporting the lowest overall quality of the signals received on the multicast channel shall have the highest influence in the summed power control commands by receiving the highest weighting factor. This UE thus constitutes in any case the multicast-power-control-master.

In a next step, the node B determines whether the weighted and summed power control commands are below zero.

In case the weighted and summed power control commands are below zero, it can be assumed that the current transmission power employed for transmitting the multicast signals is at least high enough for all of the UEs of the multicast group. The transmission power is thus reduced in a further step in FIG. 1.

In case the weighted and summed power control commands are equal to or above zero, it can be assumed that the current transmission power employed for transmitting the multicast signals is not sufficiently high at least for one of the UEs of the multicast group. The transmission power is thus increased in a further step in FIG. 1.

The node B continues transmission of the multicast signals with the adjusted transmission power, and the described closed loop power control is continued until the multicast transmission is completed.

It is to be noted that the described embodiment of the invention constitutes only one of a variety of possible embodiments.

1. Method for controlling the transmission power employed by a transmitting unit for transmitting multicast signals via a radio interface to at least two communication devices of a multicast group using a single physical channel, wherein at least the communication device of said at least two communication devices receiving said multicast signals with the lowest quality transmits power control commands to said transmitting unit, which power control commands indicate whether the transmission power employed by said transmitting unit for transmitting said multicast signals should be increased or reduced, and wherein said transmitting unit adjusts said transmission power based on power control commands received from at least one of said at least two communication devices in a way that said power control commands of said communication device receiving said multicast signals with the lowest quality have at least the most significant influence on said adjustment.

2. Method according to claim 1, wherein each of said at least two communication devices transmits power control commands to said transmitting unit, wherein said transmitting unit increases said transmission power employed for transmitting said multicast signals in case any of said communication devices transmits a power control command indicating a required increase of said transmission power, and wherein said transmitting unit reduces said transmission power only in case all of said communication devices transmit a power control command indicating that a reduction of said transmission power is possible.

3. Method according to claim 1, wherein each of said at least two communication devices transmits a quality indication to said transmitting unit, which quality indication reflects the quality of multicast signals received at the respective communication device, wherein said transmitting unit requests the communication device providing the quality indication which reflects the lowest quality of received multicast signals to transmit in addition power control commands, wherein said communication device providing said quality indication which reflects the lowest quality of received multicast signals transmits upon said request power control commands to said transmitting unit, and wherein said transmitting unit adjusts said transmission power employed for transmitting said multicast signals according to power control commands received by said communication device providing said quality indication which reflects the lowest quality of received multicast signals.

4. Method according to claim 3, wherein said transmitting unit requests another communication device to transmit power control commands instead, when said transmitting unit detects that said other communication device transmits a quality indication which indicates the lowest quality of received multicast signals.

5. Method according to claim 1, wherein each of said at least two communication devices transmits to said transmitting unit power control commands and a quality indication, which quality indication reflects the quality of multicast signals received at the respective communication device, wherein said transmitting unit weights said received power control commands based on said received quality indications in a way that the power control command from the communication device providing the quality indication which reflects the lowest quality of received multicast signals obtains the highest impact, wherein said transmitting unit sums the resulting weighted power control commands, and wherein said transmitting unit adjusts said transmission power employed for transmitting said multicast signals according to said weighted and summed power control commands.

6. Method according to one of the preceding claims, wherein power control commands indicate whether the current transmission power should be increased, reduced or remain unchanged.

7. Transmitting unit comprising means for carrying out the transmitting unit related steps of one of the preceding claims.

8. Communication device comprising means for carrying out the communication device related steps of one of claims 1 to 6.

9. Communication system comprising a transmitting unit with means for carrying out the transmitting unit related steps of one of claims 1 to 6 and at least two communication devices with means for carrying out the communication device related steps of one of claims 1 to 6.
